(19) United States
(12) Patent Application Publication
(10) Pub. No.: US 2022/0222495 A1
(43) Pub. Date: Jul. 14, 2022

(54) USING CONTEXTUAL TRANSFORMATION TO TRANSFER DATA BETWEEN TARGETS

(71) Applicant: INTERNATIONAL BUSINESS MACHINES CORPORATION, Armonk, NY (US)

(72) Inventors: Adam Oliveira, Toronto (CA); Victoria Janet Aboud, Stuttgart-Mohringen (DE); Guangjie Ren, Belmont, CA (US); Robert John Moore, San Jose, CA (US); Shun Jiang, San Jose, CA (US); Eric Young Liu, Santa Clara, CA (US); Lei Huang, Mountain View, CA (US); Peter Korsten, Utrecht (NL)

(21) Appl. No.: 17/148,042

(22) Filed: Jan. 13, 2021

(51) Int. Cl. G06K 9/62; G06N 20/00

(52) U.S. Cl. CPC G06K 9/6269; G06N 20/00; G06K 9/6232; G06K 9/6264

(57) ABSTRACT

A method, computer system, and a computer program product for contextual transformation is provided. The present invention may include providing a source application for transformation. The present invention may include transforming at least one selection within the source application. The present invention may include communicating the at least one transformed selection to a target application.

### BACKGROUND

The present invention relates generally to the field of computing, and more particularly to data transformation.

In a graphical user interface (GUI), copying and pasting may be a mechanism used to transfer multi-modal data (e.g., text, image, and/or audio data) between applications. Copying and pasting multiple selections may result in modifications to the order of the copied and pasted data. Additionally, a selection or multiple selections may be applied to one or more targets. In these instances, the format or content of the data may need to be modified to adapt to a context of the target application.

### SUMMARY

Embodiments of the present invention disclose a method, computer system, and a computer program product for contextual transformation. The present invention may include providing a source application for transformation. The present invention may include transforming at least one selection within the source application. The present invention may include communicating the at least one transformed selection to a target application.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates a networked computer environment according to at least one embodiment;

FIG. 2 is an operational flowchart illustrating a process for contextual transformation according to at least one embodiment;

FIG. 3 is a block diagram depicting intent prediction by the contextual transformation program according to at least one embodiment;

FIG. 4 is a block diagram depicting a transformation recommendation according to at least one embodiment;

FIG. 5 is a block diagram of internal and external components of computers and servers depicted in FIG. 1 according to at least one embodiment;

FIG. 6 is a block diagram of an illustrative cloud computing environment including the computer system depicted in FIG. 1, in accordance with an embodiment of the present disclosure; and

FIG. 7 is a block diagram of functional layers of the illustrative cloud computing environment of FIG. 6, in accordance with an embodiment of the present disclosure.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. Rather, these exemplary embodiments are provided so that this disclosure will be thorough and complete and will fully convey the scope of this invention to those skilled in the art. In the description, details of well-known features and techniques may be omitted to avoid unnecessarily obscuring the presented embodiments.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The following described exemplary embodiments provide a system, method and program product for contextual transformations. As such, the present embodiment has the capacity to improve the technical field of data transformation based on defined mappings by defining multiple attributes (e.g., metadata, interactional, inter-application/inter-device, and intra-application/intra-device), creating context(s) for an input based on the defined attributes, and comparing the created context(s) in order to formulate a transformation ruleset.

As described previously, in a graphical user interface (GUI), copying and pasting may be a mechanism used to transfer multi-modal data (e.g., text, image, and/or audio data) between applications. Copying and pasting multiple selections may result in modifications to the order of the copied and pasted data. Additionally, a selection or multiple selections may be applied to one or more targets. In these instances, the format or content of the data may need to be modified to adapt to a context of the target application.

Therefore, it may be advantageous to, among other things, create contexts using attributes from a source application and the one or more target applications, compare the source and target contexts to produce an intention prediction, and return a transformation recommendation.

According to the present embodiment, a method may be used to create contexts using attributes from a source application from which a user has made a selection (e.g., a copy and paste selection, a drag and drop selection) and one or more target applications. For example, the present invention may understand a context of a source application and a context of a target application to correctly perform a transformation of data from the source to the target application.

The present invention may be device and platform agnostic based on the use of a variety of techniques used to obtain input attributes, including but not limited to computer vision (CV) or a Speech-to-Text (STT) converter for audio formats.

The present invention may perform a contextual transformation by applying a mapping function to transfer one input to another (e.g., input A to input B). A transformation ruleset (e.g., a “transformation map”) may then be created after comparing derived contextual information from the source and/or target input(s).

According to the present embodiment, the method may compare the source and target contexts to produce an intention prediction and ruleset for transforming a source selection for transfer to a target application.

The present invention may be non-linear, with multiple items being able to be selected, transferred and transformed.

According to the present embodiment, the method may return a transformation recommendation and ruleset for each source selection based on a current target. The transformation recommendation and ruleset may be refreshed when a source selection or target application changes.

The recommendation system may improve as historic data grows with user feedback.

According to the present embodiment, a user may provide feedback regarding the transformation recommendation and ruleset which may be used to improve the method.

The present invention may be used, for example, when a user selects an input by copying, dragging, or screen capturing the input (i.e., input A). The user may then transfer input A by moving the selection without modifying input A to a second input (i.e., input B) by pasting, dropping, or forwarding the input across platforms (e.g., from user A to user B). A contextual transformation of the input may be done by applying a mapping function to transform input A when transferring to input B (e.g., to replace the text or reduce the image to text metadata, among other things).

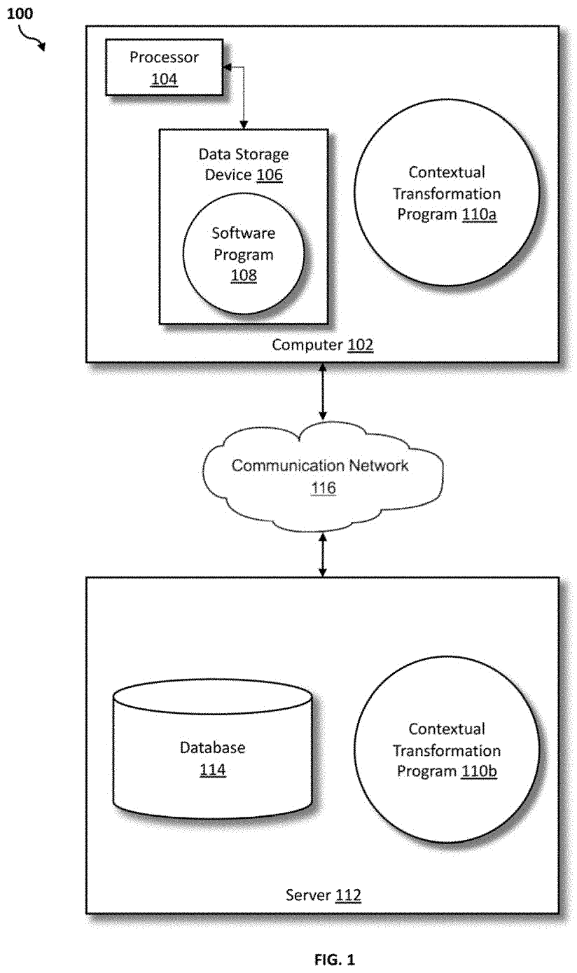

Referring to FIG. 1, an exemplary networked computer environment 100 in accordance with one embodiment is depicted. The networked computer environment 100 may include a computer 102 with a processor 104 and a data storage device 106 that is enabled to run a software program 108 and a contextual transformation program 110a. The networked computer environment 100 may also include a server 112 that is enabled to run a contextual transformation program 110b that may interact with a database 114 and a communication network 116. The networked computer environment 100 may include a plurality of computers 102 and servers 112, only one of which is shown. The communication network 116 may include various types of communication networks, such as a wide area network (WAN), local area network (LAN), a telecommunication network, a wireless network, a public switched network and/or a satellite network. It should be appreciated that FIG. 1 provides only an illustration of one implementation and does not imply any limitations with regard to the environments in which different embodiments may be implemented. Many modifications to the depicted environments may be made based on design and implementation requirements.

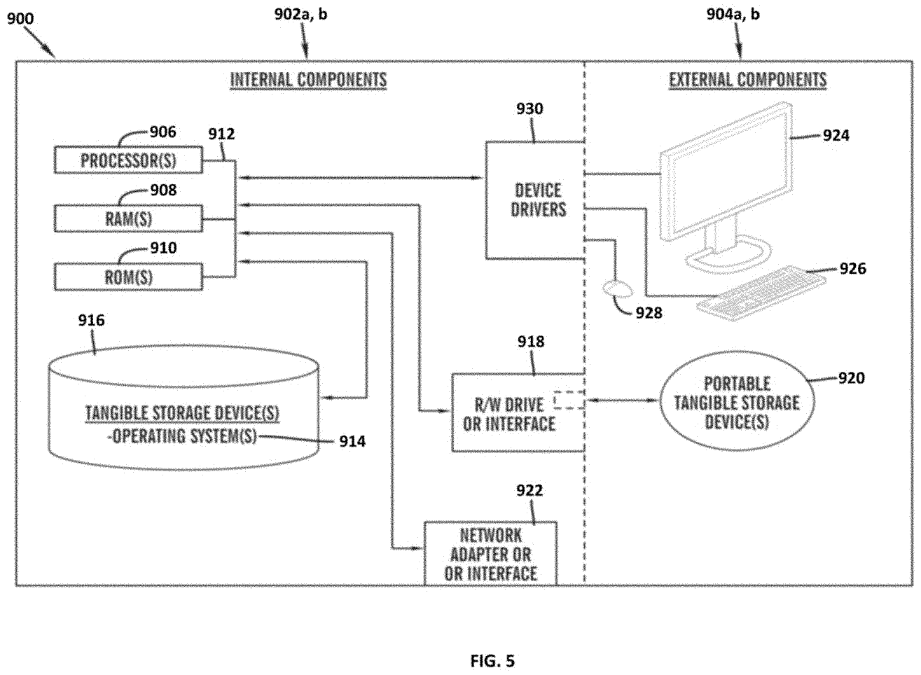

The client computer 102 may communicate with the server computer 112 via the communications network 116. The communications network 116 may include connections, such as wire, wireless communication links, or fiber optic cables. As will be discussed with reference to FIG. 5, server computer 112 may include internal components 902a and external components 904a, respectively, and client computer 102 may include internal components 902b and external components 904b, respectively. Server computer 112 may also operate in a cloud computing service model, such as Software as a Service (SaaS), Platform as a Service (PaaS), or Infrastructure as a Service (IaaS). Server 112 may also be located in a cloud computing deployment model, such as a private cloud, community cloud, public cloud, or hybrid cloud. Client computer 102 may be, for example, a mobile device, a telephone, a personal digital assistant, a netbook, a laptop computer, a tablet computer, a desktop computer, or any type of computing devices capable of running a program, accessing a network, and accessing a database 114. According to various implementations of the present embodiment, the contextual transformation program 110a, 110b may interact with a database 114 that may be embedded in various storage devices, such as, but not limited to a computer/mobile device 102, a networked server 112, or a cloud storage service.

According to the present embodiment, a user using a client computer 102 or a server computer 112 may use the contextual transformation program 110a, 110b (respectively) to formulate a transformation ruleset based on defined mappings by defining multiple attributes (e.g., metadata, interactional, inter-application/inter-device, and intra-application/intra-device), creating context(s) for an input based on the defined attributes, and comparing the created context(s).

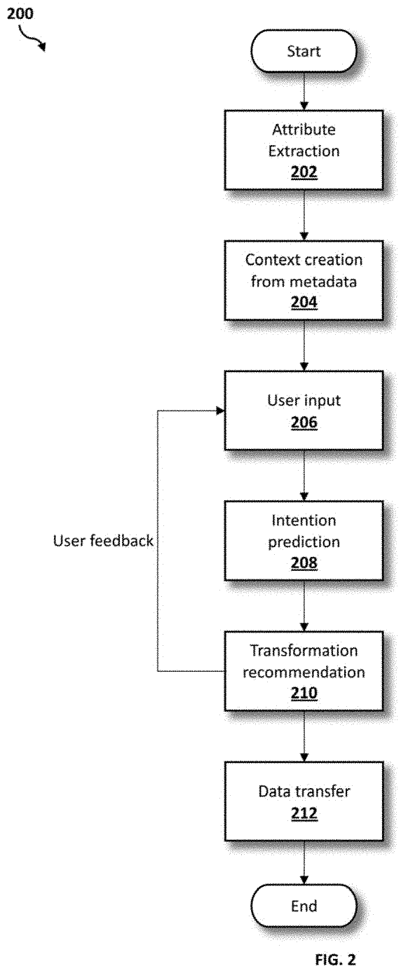

The contextual transformation method is explained in more detail below with respect to FIGS. 2 through 4.

Referring now to FIG. 2, an operational flowchart illustrating the exemplary contextual transformation process 200 used by the contextual transformation program 110a and 110b according to at least one embodiment is depicted.

At 202, attribute extraction is performed. Attribute extraction may be performed within a graphical user interface (GUI) as well as to transfer data between devices (e.g., inter-device) and/or to transfer data between applications (e.g., inter-application), among other transfers of data.

A user (e.g., a human user) provides an application or a portion thereof for transformation (e.g., the transformation of a source application to a target application) and attribute extraction of the user's selection may be performed. A source application may be a source of the data being transferred (e.g., the portion of the application provided to the user as input A) and a target application may be the location that the data is being transferred to (e.g., input B). There may be more than one attribute, as the selection may be non-linear, meaning that multiple items may be selected, transferred and/or transformed from the application.

Attributes may include metadata, interactional data, inter-application and inter-device data, and/or intra-application and intra-device data. Metadata may include time of day and/or location information, device information such as whether the devices are the same or different, user profile information such as historical data (e.g., in instances where a user profile is created to store a user's historical information), original file format (e.g., Portable Document Format (PDF)), core data (e.g., size, version, compatibility and/or portability of data), and/or multi-person collaboration, among other things. Interactional data may include general input metadata (e.g., mouse position, mouse movement history, and/or user actions), touch input (e.g., swipe length and/or pressure), and/or voice input (e.g., intonation and/or pitch), among other things. Inter-application and inter-device data may include a common data format between a source and a target application and/or historic transformation data between data formats, among other things. Intra-application and intra-device data may include a primary data format (e.g., text, image, and/or vector/scalar-based formats), a purpose of the data (e.g., productivity, word processing, form filling), and/or an agency (e.g., degree of user control and/or interactivity), among other things.

Attribute extraction may be performed by learning patterns of data (e.g., by using a supervised learning algorithm such as a support vector machine, among others), including patterns of data depicted in entities on a webpage. Entities on a webpage may have a set of attributes (e.g., a name-value pair depicting the name of the attribute and a corresponding set of values). Once webpage data is collected, a learning model (e.g., a deep learning model) may be used to learn the webpage's attributes, and a graph (e.g., a weighted graph) or a tree (e.g., a decision tree) may be created to depict attributes which are closely related. This process, including both weighted graph and decision tree, will be discussed in more detail with respect to step 204 below.

Attribute extraction may also utilize computer vision (CV) to read a visual input and to return a tree of parsed objects. CV may be a field of artificial intelligence in which computers interpret digital images and/or videos to understand the human visual system. With CV, computers may utilize deep learning models to correctly identify and classify objects that they see. In doing so, non-text selections may be converted to text. Speech to text technology, such as Watson™ (Watson and all Watson-based trademarks are trademarks or registered trademarks of International Business Machines Corporation in the United States, and/or other countries) Speech to Text, using deep-learning artificial intelligence (AI) algorithms to apply knowledge about grammar, language structure, and audio/voice signal composition may be used to perform speech recognition for text transcription.

A map data structure that indexes an identified attribute may be created by the contextual transformation program 110a, 110b, based on the attribute extraction (e.g., performed using CV or another pattern learning mechanism) to preserve the raw attribute data. The map data structure may refer to a hash map data structure which may use a hash function to compute a hash code to find a desired value. In this case, the hash map data structure may associate keys (e.g., an attribute) with values (e.g., raw attribute data).

At 204, contexts are created from a webpage's metadata. Contexts (e.g., objects or entities surrounding a focal event such as metadata appearing in a source application) may be used to determine the similarity of two attributes (e.g., the similarity of metadata appearing in a source application and metadata appearing in a target application). The map data structure created at step 202 above may be used as input at step 204 to creating a context from the webpage's metadata. A weighted graph and/or decision tree may be created here based on the inputted map data structure.

The selection and/or application attributes of the map data structure may be classified by performing text analysis to extract semantic relationships and to separate the text by attribute type (e.g., such as those described with respect to step 202 above). Extraction of semantic relationships may be performed by a support vector machine (SVM) and/or Word2vec. SVM may be a supervised machine learning model that creates a line or hyperplane which separates data into classes. SVM may be a predictive classifier that assigns new data elements to one of labeled categories based on a mathematical function which matches the new data elements to a training data element.

Word2vec models may be shallow neural networks (e.g., a type of machine learning model often used in natural language processing applications) trained using either a continuous bag of words (CBOW) approach or a skip-gram approach. For short text matching, a CBOW approach may be more accurate than a skip gram approach. Parameters such as vector size and window size may be configurable and may be adjusted depending on the application context.

A weighted graph and/or decision tree may be created based on the selection and/or application attributes of the map data structure. The weighted graph, for example, may depict attributes as graph nodes and the edges between nodes as relationships. Each edge may have a weight and a higher weight may indicate a stronger relationship between the attributes (e.g., graph nodes). A shortest path between two nodes may be determined by edges with a highest associated weight. A selection of attributes may affect the weight of each edge (e.g., the weighted graph may be updated based on a change in a context, a transformation ruleset, and/or an adjustment in user feedback such as a change in a target selection).

A decision tree and/or a weighted graph may be generated based on the learned patterns of data by the supervised learning algorithm, in an implementation of the contextual transformation program 110a, 110b. Tree and/or graph nodes may represent extracted attributes while leaves (e.g., in an implementation involving a tree) and edges (e.g., in an implementation involving a graph) may illustrate a relationship between the attributes.

In a decision tree, child nodes (i.e., outcomes) may be decisions which depend directly on a parent and ancestor node(s) (e.g., action A must lead to action B which then leads to action C).

In a weighted graph, there may be multiple paths between two different nodes. The paths may be dependent on edge weights between the nodes (e.g., action A may lead to action B or action C, dependent on X). The weights may commonly be used to mark the shortest, most efficient path between two nodes. The shortest path in a weighted graph may be in flux based on a fluctuating edge weight.

According to at least one embodiment of the present invention, the weighted graph may be used to determine which selection of attributes may predict a next action by a user. This may be useful to efficiently determine a transformation recommendation, as will be described in more detail with respect to step 210 below.

At 206, user input is received. User input (i.e., user feedback) may be data selection and/or user feedback. The receipt of user feedback may vary depending on the implementation of the contextual transformation program 110a, 110b. For example, data selection may include object metadata (e.g., data format, time of day, and/or historic number of selections of similar objects, among other things) and/or interactional metadata. Interactional data may include, for example, user interactions on a desktop GUI such as mouse and/or cursor position and movement, and/or a mouse acceleration between two points. On an audio device (e.g., a smartphone), a modality of input (e.g., a user's voice and/or intonation, among other things) may influence the interactional metadata that is received.

User feedback may include, for example, positive feedback (e.g., where a user continues an activity after a system-recommended transformation is applied) and/or negative feedback (e.g., where a user undoes a system recommended transformation because it is either incorrect and/or inappropriate). User feedback may also be based on a transformation recommendation, as will be described in more detail with respect to step 210 below.

At 208, intention prediction is performed. The weighted graph and/or decision tree of attributes for each selection and/or application, discussed previously with respect to step 204 above, may be inputted here and a tree of likely targets and/or attributes for each source selection may be outputted. The tree of likely targets may be a tree structure created for each user source selection. A root node of the tree of likely targets may refer to the user selection and each child node may represent a possible target (e.g., output) that a user may transfer the selection to.

Once a source and/or a target is identified (e.g., node A and node B in a weighted graph), the tree of likely targets may be generated based on the shortest path in the weighted graph between the two nodes.

An intention prediction (e.g., based on the weighted graph) may change based on inputted user feedback, as will be described in more detail with respect to step 210 below, a context change, and/or a modified selection by the user.

At 210, a transformation recommendation is provided. Using the tree of likely targets and/or attributes for each source selection, described previously with respect to step 208 above, as well as the current targets (e.g., an active selection by the user), a transformation recommendation may be provided to a user. The transformation recommendation may be platform agnostic and may depend on the metadata from a user's activity. For example, when implemented on a desktop GUI, the contextual transformation program 110a, 110b may provide the recommendation as a context menu that may appear adjacent to a user's mouse cursor. The context menu may contain a plain text list of the top n recommendations for the user's next action.

User feedback may influence and improve upon the system recommendation over time in addition to serving as historic training data. User feedback may be received in response to a transformation recommendation, from a human user of the contextual transformation program 110a, 110b. The received user feedback may be looped back into the contextual transformation program 110a, 110b as additional user feedback, as described previously with respect to step 206 above. The received user feedback may influence and improve upon recommendations generated by the contextual transformation program 110a, 110b and may further serve as historic training data.

In addition to providing a transformation recommendation, a structure containing a ranked source of selections with transformation functions for each target may be outputted by the contextual transformation program 110a, 110b. The transformation function may be determined based on the ruleset for object transformation between the source and the target contexts.

At 212, data is transferred. Using the steps illustrated above, the contextual transformation program 110a, 110b may transfer data (e.g., a user's selection), for example, in a cross-language currency translation from English to French, among other language translations; in a code syntax replacement from Python® (Python and all Python-based trademarks are trademarks or registered trademarks of PSF in the United States, and/or other countries) to JavaScript™ (JavaScript and all JavaScript-based trademarks are trademarks or registered trademarks of Oracle in the United States, and/or other countries), among other syntax replacements; in a multi-modal data transfer without transformation, where image and text data is uploaded to an online contact form; and in a user-specific data transformation, where inputted data is transformed based on a specification of a given user (e.g., a CFO or a shareholder), among other users. Many other contextual transformations of data for transfer between targets may be performed.

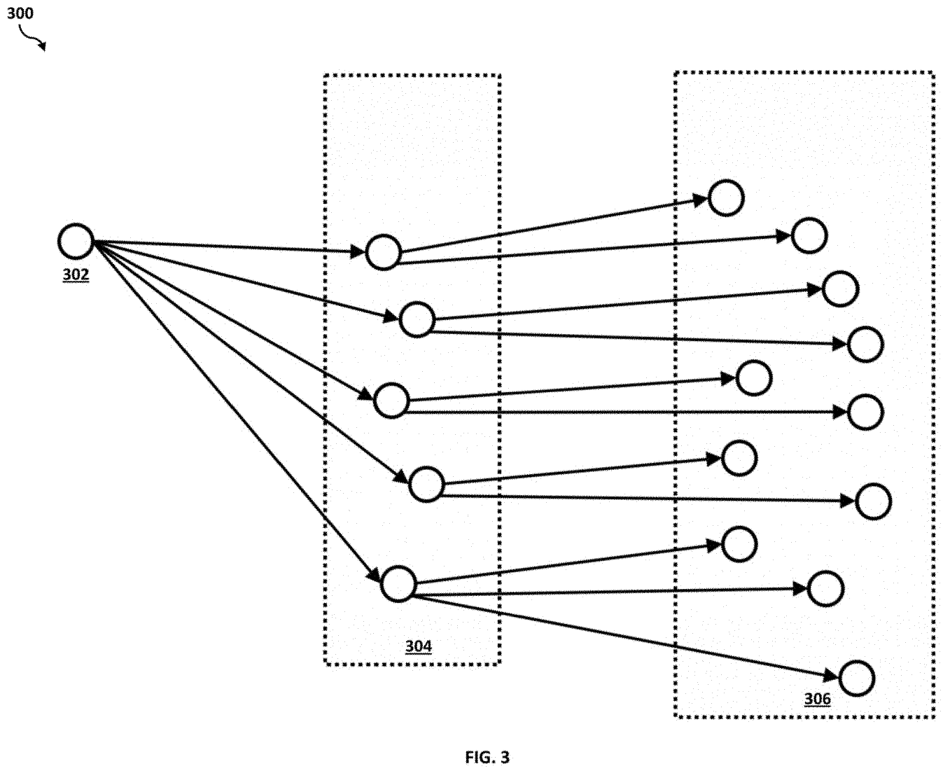

Referring now to FIG. 3, a block diagram 300 depicting intent prediction performed by the contextual transformation program 110a, 110b according to at least one embodiment is depicted. A weighted graph of attributes for each application may be received as input, with one root node 302 and multiple selections 304. A tree of likely targets and/or attributes for each source selection 304 may be outputted by the contextual transformation program 110a, 110b.

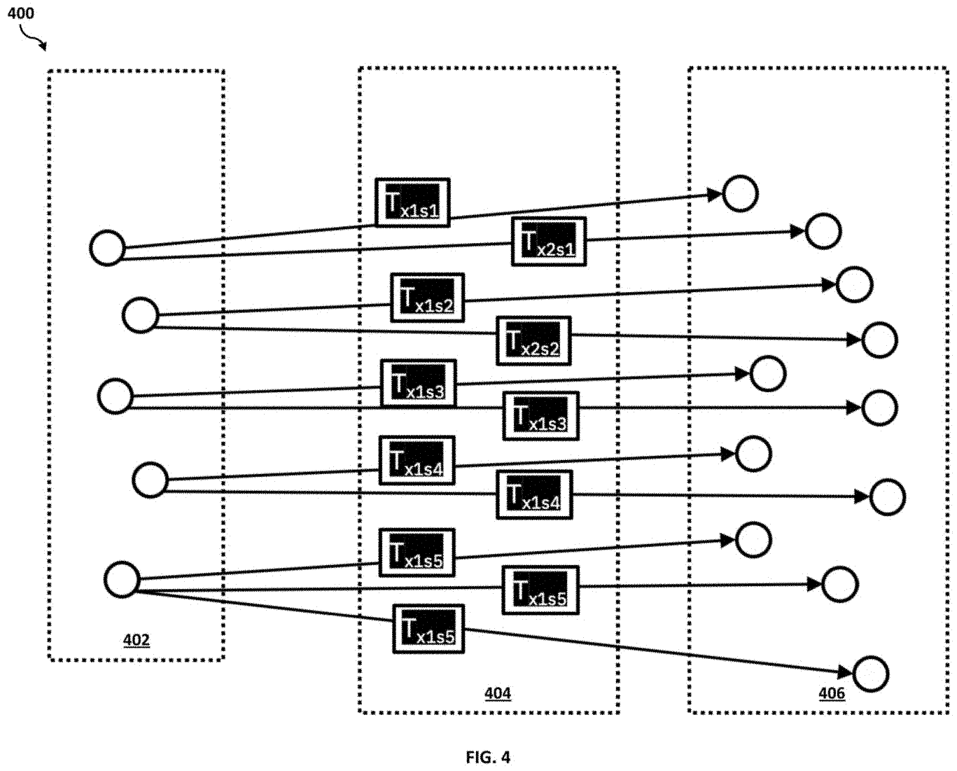

Referring now to FIG. 4, a block diagram 400 depicting a transformation recommendation according to at least one embodiment is depicted. The tree of likely targets and/or attributes for each source selection 402 may be received by the contextual transformation program 110a, 110b, and, based on a transformation function 404, a structure containing ranked source selections with transformation functions for each target 406 may be outputted by the contextual transformation program 110a, 110b.

It may be appreciated that FIGS. 2 through 4 provide only an illustration of one embodiment and do not imply any limitations with regard to how different embodiments may be implemented. Many modifications to the depicted embodiment(s) may be made based on design and implementation requirements.

FIG. 5 is a block diagram 900 of internal and external components of computers depicted in FIG. 1 in accordance with an illustrative embodiment of the present invention. It should be appreciated that FIG. 5 provides only an illustration of one implementation and does not imply any limitations with regard to the environments in which different embodiments may be implemented. Many modifications to the depicted environments may be made based on design and implementation requirements.

Data processing system 902, 904 is representative of any electronic device capable of executing machine-readable program instructions. Data processing system 902, 904 may be representative of a smart phone, a computer system, PDA, or other electronic devices. Examples of computing systems, environments, and/or configurations that may represented by data processing system 902, 904 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

User client computer 102 and network server 112 may include respective sets of internal components 902 a, b and external components 904 a, b illustrated in FIG. 5. Each of the sets of internal components 902 a, b includes one or more processors 906, one or more computer-readable RAMs 908 and one or more computer-readable ROMs 910 on one or more buses 912, and one or more operating systems 914 and one or more computer-readable tangible storage devices 916. The one or more operating systems 914, the software program 108, and the contextual transformation program 110a in client computer 102, and the contextual transformation program 110b in network server 112, may be stored on one or more computer-readable tangible storage devices 916 for execution by one or more processors 906 via one or more RAMs 908 (which typically include cache memory). In the embodiment illustrated in FIG. 5, each of the computer-readable tangible storage devices 916 is a magnetic disk storage device of an internal hard drive. Alternatively, each of the computer-readable tangible storage devices 916 is a semiconductor storage device such as ROM 910, EPROM, flash memory or any other computer-readable tangible storage device that can store a computer program and digital information.

Each set of internal components 902 a, b also includes a R/W drive or interface 918 to read from and write to one or more portable computer-readable tangible storage devices 920 such as a CD-ROM, DVD, memory stick, magnetic tape, magnetic disk, optical disk or semiconductor storage device. A software program, such as the software program 108 and the contextual transformation program 110a and 110b can be stored on one or more of the respective portable computer-readable tangible storage devices 920, read via the respective R/W drive or interface 918 and loaded into the respective hard drive 916.

Each set of internal components 902 a, b may also include network adapters (or switch port cards) or interfaces 922 such as a TCP/IP adapter cards, wireless wi-fi interface cards, or 3G or 4G wireless interface cards or other wired or wireless communication links. The software program 108 and the contextual transformation program 110a in client computer 102 and the contextual transformation program 110b in network server computer 112 can be downloaded from an external computer (e.g., server) via a network (for example, the Internet, a local area network or other, wide area network) and respective network adapters or interfaces 922. From the network adapters (or switch port adaptors) or interfaces 922, the software program 108 and the contextual transformation program 110a in client computer 102 and the contextual transformation program 110b in network server computer 112 are loaded into the respective hard drive 916. The network may comprise copper wires, optical fibers, wireless transmission, routers, firewalls, switches, gateway computers and/or edge servers.

Each of the sets of external components 904 a, b can include a computer display monitor 924, a keyboard 926, and a computer mouse 928. External components 904 a, b can also include touch screens, virtual keyboards, touch pads, pointing devices, and other human interface devices. Each of the sets of internal components 902 a, b also includes device drivers 930 to interface to computer display monitor 924, keyboard 926 and computer mouse 928. The device drivers 930, R/W drive or interface 918 and network adapter or interface 922 comprise hardware and software (stored in storage device 916 and/or ROM 910).

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

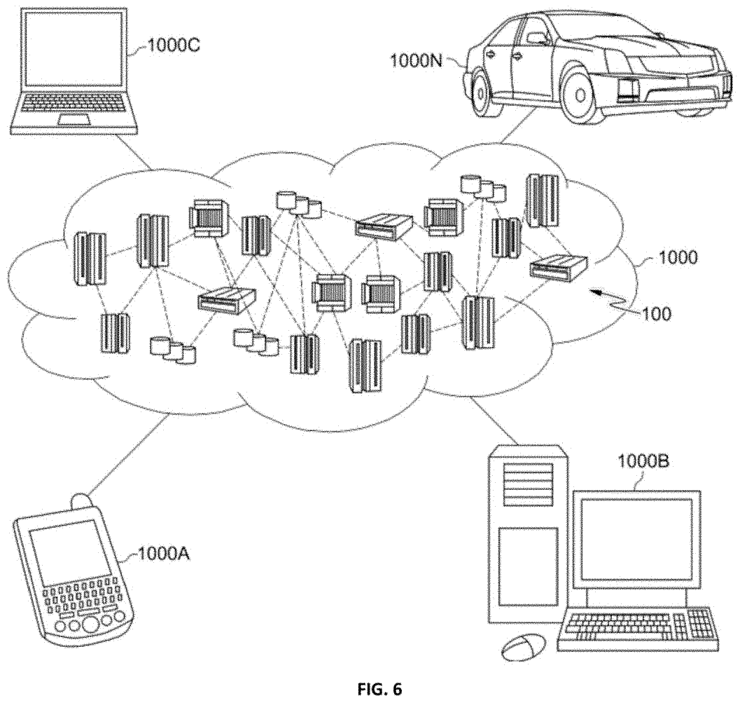

Referring now to FIG. 6, illustrative cloud computing environment 1000 is depicted. As shown, cloud computing environment 1000 comprises one or more cloud computing nodes 100 with which local computing devices used by cloud consumers, such as, for example, personal digital assistant (PDA) or cellular telephone 1000A, desktop computer 1000B, laptop computer 1000C, and/or automobile computer system 1000N may communicate. Nodes 100 may communicate with one another. They may be grouped (not shown) physically or virtually, in one or more networks, such as Private, Community, Public, or Hybrid clouds as described hereinabove, or a combination thereof. This allows cloud computing environment 1000 to offer infrastructure, platforms and/or software as services for which a cloud consumer does not need to maintain resources on a local computing device. It is understood that the types of computing devices 1000A-N shown in FIG. 6 are intended to be illustrative only and that computing nodes 100 and cloud computing environment 1000 can communicate with any type of computerized device over any type of network and/or network addressable connection (e.g., using a web browser).

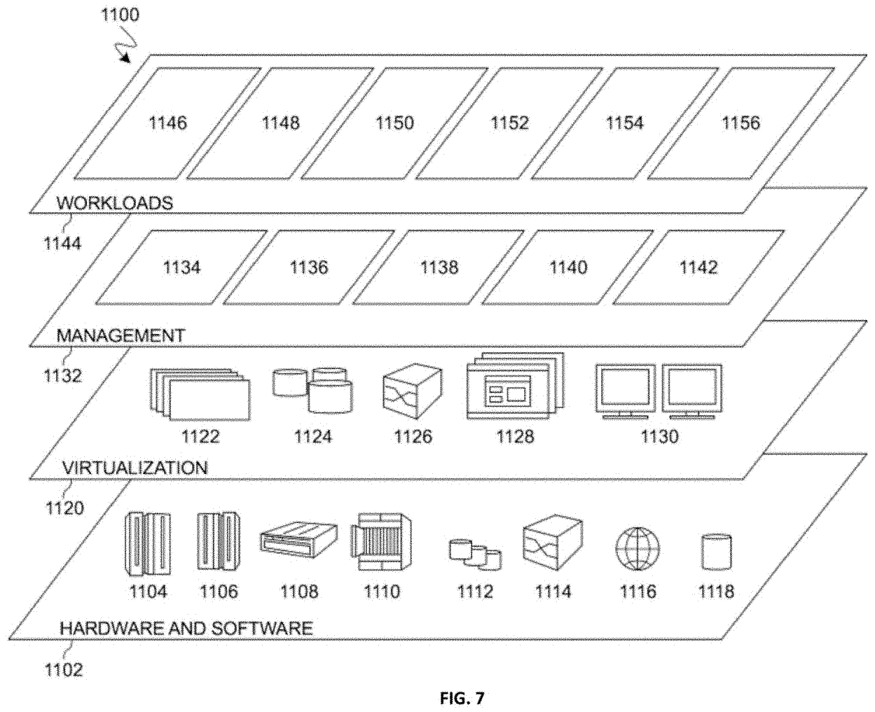

Referring now to FIG. 7, a set of functional abstraction layers 1100 provided by cloud computing environment 1000 is shown. It should be understood in advance that the components, layers, and functions shown in FIG. 7 are intended to be illustrative only and embodiments of the invention are not limited thereto. As depicted, the following layers and corresponding functions are provided:

Hardware and software layer 1102 includes hardware and software components. Examples of hardware components include: mainframes 1104; RISC (Reduced Instruction Set Computer) architecture based servers 1106; servers 1108; blade servers 1110; storage devices 1112; and networks and networking components 1114. In some embodiments, software components include network application server software 1116 and database software 1118.

Virtualization layer 1120 provides an abstraction layer from which the following examples of virtual entities may be provided: virtual servers 1122; virtual storage 1124; virtual networks 1126, including virtual private networks; virtual applications and operating systems 1128; and virtual clients 1130.

In one example, management layer 1132 may provide the functions described below. Resource provisioning 1134 provides dynamic procurement of computing resources and other resources that are utilized to perform tasks within the cloud computing environment. Metering and Pricing 1136 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 1138 provides access to the cloud computing environment for consumers and system administrators. Service level management 1140 provides cloud computing resource allocation and management such that required service levels are met. Service Level Agreement (SLA) planning and fulfillment 1142 provide pre-arrangement for, and procurement of, cloud computing resources for which a future requirement is anticipated in accordance with an SLA.

Workloads layer 1144 provides examples of functionality for which the cloud computing environment may be utilized. Examples of workloads and functions which may be provided from this layer include: mapping and navigation 1146; software development and lifecycle management 1148; virtual classroom education delivery 1150; data analytics processing 1152; transaction processing 1154; and contextual transformation 1156. A contextual transformation program 110a, 110b provides a way to formulate a transformation ruleset based on defined mappings by defining multiple attributes (e.g., metadata, interactional, inter-application/inter-device, and intra-application/intra-device), creating context(s) for an input based on the defined attributes, and comparing the created context(s).

The descriptions of the various embodiments of the present invention have been presented for purposes of illustration but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for contextual transformation, the method comprising:
providing a source application for transformation;
transforming at least one selection within the source application; and
communicating the at least one transformed selection to a target application.

2. The method of claim 1, further comprising:
selecting multiple items within the source application.

3. The method of claim 2, further comprising:
transforming each of the multiple items based on the target application.

4. The method of claim 2, further comprising:
transferring each of the multiple items based on the target application.

5. The method of claim 1, further comprising:
receiving a plurality of user feedback; and
modifying the transformed selection based on the plurality of user feedback.

6. The method of claim 1, further comprising:
using a hash map data structure to index at least one extracted attribute from the source application and the target application.

7. The method of claim 6, further comprising:
classifying the at least one extracted attribute using a support vector machine (SVM) supervised machine learning model to predict a next action of a user.

8. A computer system for contextual transformation, comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
providing a source application for transformation;
transforming at least one selection within the source application; and
communicating the at least one transformed selection to a target application.

9. The computer system of claim 8, further comprising:
selecting multiple items within the source application.

10. The computer system of claim 9, further comprising:
transforming each of the multiple items based on the target application.

11. The computer system of claim 9, further comprising:
transferring each of the multiple items based on the target application.

12. The computer system of claim 8, further comprising:
receiving a plurality of user feedback; and
modifying the transformed selection based on the plurality of user feedback.

13. The computer system of claim 8, further comprising:
using a hash map data structure to index at least one extracted attribute from the source application and the target application.

14. The computer system of claim 8, further comprising:
classifying the at least one extracted attribute using a support vector machine (SVM) supervised machine learning model to predict a next action of a user.

15. A computer program product for contextual transformation, comprising:
one or more non-transitory computer-readable storage media and program instructions stored on at least one of the one or more tangible storage media, the program instructions executable by a processor to cause the processor to perform a method comprising:
providing a source application for transformation;
transforming at least one selection within the source application; and
communicating the at least one transformed selection to a target application.

16. The computer program product of claim 15, further comprising:
selecting multiple items within the source application.

17. The computer program product of claim 16, further comprising:
transforming each of the multiple items based on the target application.

18. The computer program product of claim 16, further comprising:
transferring each of the multiple items based on the target application.

19. The computer program product of claim 15, further comprising:
receiving a plurality of user feedback; and
modifying the transformed selection based on the plurality of user feedback.

20. The computer program product of claim 15, further comprising:
using a hash map data structure to index at least one extracted attribute from the source application and the target application; and
classifying the at least one extracted attribute using a support vector machine (SVM) supervised machine learning model to predict a next action of a user.
